(19) United States
(12) Patent Application Publication
(10) Pub. No.: US 2008/0235070 A1
(43) Pub. Date: Sep. 25, 2008

(54) Method and System For Processing and/or Managing Typesetting Orders For Advertisements in Print and/or Online Media and Corresponding Computer Program and Corresponding Computer-Readable Storage Medium and Data Management Method For Distributed Object-Oriented Workflow Systems

(76) Inventor: Jochen Seliger, Berlin (DE)

Correspondence Address: THELEN REID BROWN RAYSMAN & STEINER LLP, P.O. BOX 640640, SAN JOSE, CA, 95164-0640, US

(21) Appl. No.: 12/090,094

(22) PCT Filed: Oct. 16, 2006
(86) PCT No.: PCT/EP2006/067467

§ 371 Date: Apr. 28, 2008

(30) Foreign Application Priority Data
Oct. 14, 2005 (DE) 10 2005 050 287.3

(51) Int. Cl. G06Q 10/00; G06F 17/30

(52) U.S. Cl. 705/8; 707/103 R; 707/E17.055

(57) ABSTRACT

The invention is directed to a method and a system for processing and/or managing typesetting orders for advertisements in print and/or online media, as well as a corresponding computer program and a corresponding computer-readable storage medium, which can be used, in particular, to provide greater flexibility and automation of the entire production process of digital advertisement designs for press, print and the other media enterprises.

To this end, a workflow system is provided which represents, controls and automates the production of digitally produced advertisement designs (motifs) from the time the commercial advertisement order is stored in the advertisement management system until the time the completed designs are transferred as generic print data or derivatives thereof to the corresponding communicating downstream systems. The control and communication characteristics of the system can be affected and set up through Customizing commensurate with the requirements of the respective customer.

The invention relates to a method and a system for processing and/or managing typesetting orders for advertisement in print and/or online media, and a corresponding computer program and a corresponding computer-readable storage medium, and a method for data management in distributed object-oriented workflow systems, which can be employed in particular to add flexibility and to automate the entire production process of a digital advertisement designs for press, print and other media enterprises.

Conventional production methods for advertisement designs tend to use multipage paper document (typically placed in a plastic leaf folder) for controlling the production process.

This folder initially always contains a printout of the commercial advertisement order. Optionally, other paper documents are added (hand drawings, faxes, etc.), which illustrate additional information about visual representation of the typeset advertisement to be designed, as well as logos added by the client, possibly in digital form. These folders represent the controlling element in a traditional process. The processes and processing speeds of the data communication in conventional production settings pose another problem.

Significant downtimes/wait times already occur in a local network (LAN) due to the length of time required for opening voluminous data generated, in particular, by the desktop application from a LAN-Share enabled in the network and/or storing the data on such Share. Particularly severe are the problems related to the integration of external service providers in the production process.

If a LAN-Share is published under such conditions, which are difficult to avoid when using conventional means, by using a point-to-point connection between service provider and publishing houses, then additional permanent costs are incurred by leasing the point-to-point connections which are in addition to the limitations due to the line capacity.

The disadvantages resulting from the aforementioned conditions are:
Late information about the advertisement orders to be processed (delivering the order manuscripts via pneumatic tubes, couriers and other outdated transport methods),
The delivered digital data must be administered separately,
These folders must be handled multiple times by different persons, due to different processing steps and production methods, transferred from one work area to the next and possibly sorted again several times in the central storage shelf. The order documents representing the controlling element of the conventional production process may therefore need to be searched (if changes have been made), which takes time at the different work locations,
Technical processing steps (PDF generation, fax generation, transmission over different communication paths) are performed manually, which is very time-consuming,
Organizing the work targeted for specific orders (e.g., for pre-products or specific wishes from individual customers for specific inspection dates) can only be visualized in very rudimentary form,
Visualizing the process steps reflecting developments in the market, where entire production runs from big clients (newspaper publishing houses) need to be delivered to subcontractors or subcontractors should be included in a production process, is difficult to implement and has a high error rate,
Different required process steps (e.g., if the design is delivered in digital form by a typesetting studio or additional processing of delivered logos by suitable personnel) must be organized and visualized with the leaf folder in form, which is complex to implement,
The “workload” of the various functional areas can be controlled only with moderate success. As a result, a lot of time is used to repeat technical processes; errors are made under time pressure,
Control of typesetting orders delivered “late” or changes to orders being processed is very inefficient with the production process, which necessitates early deadlines for advertisements,
The technical communication of the completed designs to, for example, the customer/consultant for evaluation within the respective production process, as well as to downstream systems or receiving systems of cooperating partners or large customers after the design is completed, must be performed manually and is subject to errors,
Deadlines for completing individual typesetting orders (e.g., fax or typesetting drafts) and/or groups of such orders (e.g., pre-products), in particular individual orders, are difficult to visualize in the production process,
Reaction to short-term changes in the deadlines is limited,
The increasing variety of targeted deadlines can no longer be reliably visualized in the production process,
The production process frequently requires data of LAN-Shares to be loaded or stored, which causes significant downtime, causing the overall economic result of the enterprise to deteriorate,
Print deadlines can then no longer be met, resulting in dissatisfaction of the customers,
Finally, individual customers (cooperation partners) will complain that typesetting orders are not completed on time or contain errors.

Conventional proposals for solving the aforementioned problems include, among others,
Limiting the number of repeats and variety in the technical processing and functional process flow (only two PDF transmissions per order, no telephone calls for “small” and “uncomplicated” orders),
“Advancing” an increasingly larger number of groups of orders, or
Satisfying the requirements due to the changing “Workload” by increasing the number of daily work hours and/or by shifting additional work time to the weekend (not cost-effective).

These proposals are only able to remedy parts of the aforementioned deficiencies, do not exploit the potentially existing technical possibilities and have typically a negative impact in other places (such as cost, quality or processing time for an order).

It is therefore an object of the invention to provide a method and system for processing and/or managing typesetting orders for advertisement in print and/or online media, and a corresponding computer program and a corresponding computer-readable storage medium, and a method for data management in distributed object-oriented workflow systems, which eliminate the aforementioned deficiencies and, more particularly, represent the control of schedules and organization of the typesetting production in a technical system. The object is attained with the invention with the features recited in claim 1, 21, 22, 25, and 26. Advantageous embodiments of the invention are recited in the dependent claims.

In a preferred embodiment, the system is used for managing and controlling the production process in pre-press facilities of newspaper publishing houses and similar service organizations.

More particularly, it makes it possible to control of the scheduled finalization of all typesetting orders to be produced in a pre-press operation, independent if standard products, pre-products or orders with intermediate capability for corrections by the author.

Using its internal logic, the system controls processing of the required operations for the typesetting orders in the “correct” formal sequential order so that those production tasks that are “most urgent”, i.e., when arranged according to their finalization date, are always performed by the designated workers.

The system also allows orders delivered late to be produced reliably and to shift the advertisement deadlines closer to the respective production date, as well as replacing paper manuscripts with a digital manuscripts, thereby transitioning entirely to a “digital workflow.” The system also enables in-depth control of the entire production process.

According to a particular advantage of the process of the invention, all typesetting orders to be produced are visualized in the system of the invention and recurring technical processes are automated. This is attained by the invention in that program modules are provided on at least one data processing system, which enable modeling of predefinable processing steps in processing of typesetting orders. A self-contained production process is associated with a typesetting order, and the production process is configured by combining and configuring program modules to the production process depending on the typesetting order, such that the production process is assembled as a sequence of these program modules (steps/processing steps). During the initial instantiation or change of an already instantiated production process, a required finalization date is automatically determined at least for a portion of the production processes and associated with the corresponding production process.

The production processes are matched to one another such that the finalization dates of the production processes satisfy predeterminable criteria, and a priority is associated with the production processes depending on the finalization date.

During processing of a typesetting order exactly one program module of the production process associated with this typesetting order (the actual step) is released for processing (“active”), and transfer of this production process from one program module to the immediately following program module is controlled by parameterizable transition functions (transfer functions). The process change depends on the results from the transition functions.

Preferably, the program modules include computer programs and database structures. These enable modeling of the individual, predefinable steps which represent a single processing step in the processing of typesetting orders.

In a preferred embodiment of the process of the invention, typified workflows are assembled from these program modules (steps) as flows. A production process associated with a typesetting order is instantiated by reference to such (typified) flow.

According to a preferred embodiment of the process of the invention, programs and database structures are provided on at least one data processing system, enabling modeling of individual, predefined steps that corresponds to the process steps in the processing of typesetting orders, as well as flows which correspond to typified work flows in typesetting production. In the production environment, a dedicated production process is associated with a corresponding typesetting order, and the production process is instantiated by referencing a modeled flow, so that the production process is instantiated, processed and optionally changed with the sequence of processing steps modeled in the flow, a finalization date is automatically determined when a new production process starts or an existing production process is changed and associated with the corresponding production process, the production processes are matched to one another such that the finalization dates of the production processes satisfy predeterminable criteria, and a priority is associated with the production processes according to their finalization date.

When a typesetting order is processed, exactly one program module/processing step/step of the production process (the actual step) associated with this typesetting order is released for processing and parameterizable transition functions can be triggered when transitioning from one program module to the following program module.

According to another preferred embodiment of the process of the invention, the production processes are configured as sequential processes with possibilities for recursion and editing. Advantageously, the production process can be modified while a production process is performed, by adding program modules to the production process or removing program modules from the production process. By enabling program modules (steps/processing steps) of a production process to release already processed program modules (steps/processing steps) of this production process for repeat processing, cross-references can be made for corrections, additions and the like.

Changes desired by a customer can then also be accommodated which may require new process steps to be performed or existing process steps to be performed differently.

In another preferred embodiment of the method of the invention, the transition functions may automatically parameterize actions, such as PDF generation, fax generation, transmission of EPS data to predefined addresses and/or setting EPS data in a predefined advertisement system, and execute these actions depending on the process status and customizing.

In another preferred embodiment of the method of the invention, in typesetting orders with several advertisement motifs, a separate production process may be associated with each advertisement motif.

According to another preferred embodiment of the process of the invention, at least a portion—preferably all—of the data to be managed for a production process are administered in a single uniform process-related directory structure (order folder), and made available to each program module.

In a preferred embodiment, these data may also include the digitized design manuscripts, which completely eliminates order folders with paper documents, transitioning to an entirely digital workflow. According to another preferred embodiment of the invention, the aforementioned order folders are automatically transferred by a data management system to those files servers or desktop computers where the program module (step) is to be performed (see Step Customizing).

In the preferred embodiment, the required communication is implemented via the Internet, thus obviating the need for point-to-point connections between users.

The order folder represents the central entity in the data management system.

According to a method of the invention for data management in distributed object-oriented workflow systems, data are transmitted between the different data processing systems via the Internet by invoking a method of a remote object (Remote Method Invocation=RMI), and data transmission from a target data processing system is automatically started upon reaching predetermined process steps by starting a thread, a source data processing system transmits the requested data to the target data processing system as an argument of a method in a byte stream, and the transmitted data are saved on the target data processing system in a directory structure, such that storage location and directory structure on the target data processing system correspond to the storage location and the directory structure on the source data processing system.

A skilled artisan will appreciate that a system and/or a computer program can be provided which are configured to perform the method of the invention for data management in distributed object-oriented workflow systems; likewise, such computer program can be stored on a computer-readable storage medium.

Advantageously, the production process can be readily controlled via a system GUI (Graphic User Interface) for user input, which offers detailed information about the currently processed processing step/step, displays the underlying production process/production order and allows access to program functionalities via function menus. For example, transfer from one program module to another program module may be enabled only through user input.

Advantageously, the language for operating a GUI may be configured user-specific. This is particularly relevant if the production is carried out at different international sites or in a multilingual environment.

In certain situations, the production occurs decentralized at different locations, for example, when parts of the production orders are sent to subcontractors. In these situations, with the system of the invention, processing steps on data processing systems can be performed at different physical locations, by providing the process information required for performing the processing step(s) via the GUI and Internet communication, and by having the data management system transfer the order file folder associated with the production order to the corresponding file server or desktop computer, which would then be accessible to the user with minimal access times.

According to a preferred embodiment of the method of the invention, a message is displayed if a production process reaches and/or exceeds a predetermined point in time ahead of the finalization date.

According to another preferred embodiment of the method of the invention, controlling can be performed while the production orders are processed and during the individual processing steps.

A system for processing and/or managing typesetting orders for advertisement in print and/or online media according to the invention, including at least one data processing device, wherein program modules are provided on the data processing device(s) that correspond to individual presettable processing steps when processing typesetting orders, and wherein the system is configured for executing a process for processing and/or managing typesetting orders for advertisements in print and/or online media according to at least one of claims 1 to 20.

According to another preferred embodiment of the system of the invention, database structures and the program logic enable modeling of process steps/steps and flows, as well as instantiating production processes based on the modeled flows and on the data of the commercial advertisement orders imported via the import interfaces.

Advantageously, at least one computer program is used (which advantageously includes a database structure) for managing and controlling the processing of typesetting orders to be produced, which enables at least one computer, after the program is loaded into the memory of the computer, to perform a method for processing and/or managing typesetting orders for advertisements in print and/or online media according to at least one of claims 1 to 20.

For example, these computer programs (for a fee or without fee, freely accessible or password-protected) can be provided for downloading in a data or communication network. The computer programs provided in this manner can then be used by a method wherein a computer program according to claim 25 it is downloaded from an electronic data network, such as the Internet, to a data processing system connected to the data network.

The invention also provides a computer-readable storage medium, on which at least one program and optionally the database structure definitions are stored, which enable at least one computer, after they are loaded into the memory of the computer, to perform a method for processing and/or managing of typesetting orders for advertisements in print and/or online media according to at least one of claims 1 to 20.

The system of the invention has, in particular, the following advantages:

The system represents the processing paths to be executed for the orders to be produced as processes.

This is based on the following process logic:

Steps, which represent the processing steps, or positions, to be executed in the processing method, are the basic entity for all planes of modeling and processing of the processes.

These are referred to at the elementary plane as STEPS. In programming context, they can be described as of objects with attributes. They are also persistently represented by database entries. At this plane, they only include attributes, for a unique ID in the stored table, the ID of the CLIENT (large client), the “inbound” and the “outbound” function, the server executing the defined steps (distributed production) and the identifier which indicates that the order folder, when this step (in the process) is invoked for processing, is to be transferred to the local hard drive of the computer on which the invoking user is logged on.

On the second model plane, where the flows are modeled, the steps of the first plane are referenced (the flows steps inherit the attributes of the steps, and augment them further). The flow steps then have additional attributes of the ID of the modeled flows and of the position of the particular step within the sequence of the flow. The basic steps can be referenced in an any number of flows. They always carry initially the concrete attributes of the referenced step, but are augmented with the data of the concrete flows and the respective position. These data are also persistently written to the database. The actual production processes are then instantiated at the import interfaces by referencing these guidelines. For each production process, a header is inserted into a corresponding table with attributes of those parameters that are valid for the entire process, such as width and height, coloration, customer ID, etc. For each step of the basic flow, a process step record is entered in the corresponding database table, which in addition to the attributes inherited from the flow step includes a number of additional attributes for representing the states of the production process and for satisfying the Controlling requirements.

The production process is “transformed” via this process step. If necessary, this sequence is adapted to the production requirements by adding or deleting process steps.

The production processes are processed by the system based on the information about production processes and process steps stored in the database structures as well as their status characteristics. The most important information that triggers continuation of a process are “user inputs” (“Done” message for the steps in the process).

The structure of the production process can be changed within limits during its “lifetime” so as to implement ad hoc requirements. Steps can be inserted in and deleted from the portion of a production process that has not yet been processed. If processing needs to be partially repeated at a certain position, for example when an error has been detected (e.g., by the in-house proofreader, requiring corrections on the Quark layout), then the system represents this recursion at any constellation in the process.

The process logic of the system of the invention ensures a flexible reaction to particularities and required changes in the production process.

The system can be operated multilingual. Each user has the option, if set up in Customizing, to select the desired interface language of his/her GUI.

The system uses a dedicated user authentication and authorization system.

The system initially distinguishes between user types, which are “administrators”, “production managers”, “team leaders” and “clerks”.
Administrators have access to Customizing and can view all production orders (including the actual process steps) of all clients, but may not change them (except for error handling and corrections).
Production managers are assigned in Customizing the responsibility for the production of one or several clients. They can therefore view the production data of these clients and monitor their production.
Team leaders can view, if set up in Customizing, in addition to their “own” production orders the orders from the members of their respective team (with the currently “active” process step).
Clerks can only view the current processing step of production orders, if the actual process step (of the corresponding client) is included in the duty list of the respective user. In this way, the responsibilities in the production process can be efficiently controlled and organized.

The system of the invention uses duty lists in the user records to reliably and flexibly organize the content-related operations in the production process.

With the system, productions from different clients can be represented. Initially, large customers (e.g., newspaper publishing houses) which have their respective advertisement production, or parts thereof, performed by a company that uses the method of the invention, can be set up as clients, but also special products to be produced separately (e.g., incidental production, University newspaper).

Advantageously, Customizing is done separately for each represented client. The production can be, but need not necessarily be, logically separated for each client. Mixed implementations are also possible (which are implemented with the duty lists described in more detail below).

The system allows secure organization and execution of the production at different production sites. The system enables the organization and execution of the production by including external service providers. External service providers refers to typesetting companies, which are asked by the company using the system of the invention for controlling the production process for layout of advertisements, to implement, if necessary, certain processing steps (frequently typesetting with a desktop publication application—for example, Adobe “InDesign”). Also feasible in this context would be the desire to transfer responsibility for importing and checking the consistency of the digital design data imported with certain systems (e.g., “Solvero” and “Asura” from the company “One Vision”) to an external company which, unlike the company that uses the system of the invention for controlling the production process for advertisement designs, owns these systems.

The system of the invention for controlling the production process for advertisement designs includes the required logic and functionality to enable such constellations by integrating the logic and dataflow of the external service provider in the production environment that is organized with the system of the invention for controlling the production method for advertisement designs.

The system allows a variety of automated technical processing and communication methods.

The relevant data are transferred from the advertisement management system(s) through technical interfaces. The information about all orders to be produced is therefore available in the production system with only a slight delay after the commercial advertisement order has been stored.

In a preferred embodiment, this system represents each motif (in advertisement orders with several motifs) as a separate production order. A production order is to be understood as the commercial equivalent of the production process, wherein production processes are sequences of steps to be processed and therefore processing steps for a single production order. In this preferred embodiment, such production order is logically visualized for each, optionally different, motif of each commercial advertisement order to be processed (e.g., a satellite display). Different equivalents to the advertisement order are generated. Because the originally instantiated sequences of steps may have to be changed during the production process, which is possible with the system, these processes are called “live” processes. While the two equivalents of the advertisement order manage information content which is not entirely identical, they represent the order for realizing the design set for a particular commercial advertisement order (its motif) from a different view. Both equivalents are managed in the data structures of the system of the invention.

Each production order is assigned a technical finalization date (determined by the first print date of the particular advertisement motif) at the time of the instantiation. This finalization date is the most important controlling information for all production orders. This date can still be edited at a later time (e.g., to represent pre-products or special requests from a customer). All production orders/processes which need to be processed on a specified date are always represented on a consistent time line. The order with the earliest finalization date (with its actual “active” processing step), is always shown at the top.

The processing paths/production processes to be performed (comprising, for example, of “Commercial order capture”, “Advertisement preparation”, “Set with Quark”, “In-house correction”, “Author/customer correction”, “Completion notice of the production process”) are modeled as flows based on steps and finally instantiated as production processes.

In a preferred embodiment of the invention, all traditional processing stations (such as the design system(s) or advertisement preparation) are established as Steps. Additional applications in the production process can then optionally be started “via” these steps (e.g., “Quark Xpress” at a step “Typesetting with Quark”). This is done via interfaces of the system, which transfer the required data from the commercial order to the typesetting tool.

However, Steps representing a single signal (e.g., for confirmation from the customer that the corresponding design is available, or for representing the result from a customer correction) can also be represented.

With the system, both periodic pre-products and sporadic special products, including the on-time control of the advertisement orders from these products, can be represented by the production process. A reliable, time-managed and flexible production is attained by calculating finalization dates at the import interface, enabling targeted or group-wise changes (pre-products, special products) and organizing processing of the production orders based on these dates/times on a consistent timeline.

The system ensures automatic data management for all data associated with the production order by way of an automatic transport layer, while preventing downtimes during the required transfer. The system manages order folders with all the data relevant for a particular production order in a similar directory structure. The order folder of the production order which holds all the relevant data from the respective production order, represents the central entity within this data management.

The order folder includes both the optionally stored design manuscripts, the native and generic data generated by the typesetting tool, optionally logos associated with the production order, etc. Access to these order folders is provided by the system functions; access to the file system with these order folders via the LAN manager is not required. The system of the invention for controlling the production process for advertisement designs communicates the order folders automatically between the servers (see “distributed production”) as well as a between production server and desktop computer. With this method, the typesetting tools as well as all other tool for representing data can be read from and stored on the local hard drive.

To provide an entirely digital workflow (as an alternative to manual transport of paper documents), the system includes, in addition to the digital representation of the commercial and technical production data in a database, those functionalities which make it possible, on one hand, to scan design layouts using system-internal methods at a particular process step (e.g., “advertisement preparation” or “commercial order capture”), including automatic naming, type conversion and storage of these scanned data in a subdirectory of the respective order folder, and on the other hand, to represent the digitized information at any desired step of the respective process. This approach completely eliminates the use of the aforedescribed leaf folders with paper documents, and the production can be represented by a digital workflow.

In order to represent the market demands for decentralization of the production, the system also includes an automatic transport layer. This layer is part of the data management system and ensures that the order folder of the respective production order is automatically transported to the particular server referenced by the step to be processed, when the respective step becomes an “active” step of the process.

The entire content of the respective order folder is bundled and compressed at the source, transmitted via system-internal methods via the Internet to the destination (the target server), where the content is decompressed and unbundled into the corresponding directory of the file system.

This transfer is transparent for the user of the system. During execution of the production process, this transfer is processed asynchronously, as part of the transition functionality, within a dedicated thread. As a result, the users of the system do not experience downtimes, while opening and storing data from or to a remote file system. All necessary information is available at each logical step and at each actual production site with minimal access times, because all relevant information of a production order is managed in the database and supplied by the data management system with the order folder.

The system enables representation and organization of international production scenarios at any remote location.

Management of the process flow data of all process production orders with great detail by the system of the invention enables controlling of the entire production process with the goal to detect bottlenecks in the production as well as to eliminate these bottlenecks and to prevent recurring errors.

All data required for billing the responsible publishing house and/or the customer for the work performed by the typesetting company can be obtained from the system.

In a preferred embodiment, the system satisfies specific requirements for timeliness, flexibility and automation of the entire production process of digital advertisement design for press, print and other media enterprises.

The system can be advantageously employed in both preliminary stage operations within publishing houses, but also in typesetting service providers which performs work for media companies, and reduce costs. The system is particularly suited for controlling and automating the production of advertisements for printed products, which are printed daily or several times a day, and/or for complex print products, where the production needs to be particularly effective and timely.

Important aspects of the invention can be summarized as follows:

The solution is divided into functional and logical modules.
Content-related
   a.1 Customizing
   a.2 Operation
Structural
   b.1 Client
   b.2 Server
Functional
   c.1 Database server
   c.2 Production server
   c.3 Production client computer
Process model
Instantiation model

With the aforedescribed solution, systems of any complexity with respect to content and structure can be configured, depending on the requirements of the operators. This is based, on one hand, on Customizing, which is used to configure the general, (client-) originator-specific, the client-independent, and the client-specific settings, and on the other hand, the program logic which references these settings and controls therewith functional task assignments to the users and execution the automatic processing during operation. In this way, production flows can be set up for any number of originators, for any processing steps (Steps), optionally specific for each of the set-up originators, arbitrary workflows as typical process flows, and the individual association of responsibility of the users by referencing steps and the duty-list of the users and an unlimited number of remote production servers, archiving servers and transfer servers for transferring the completed production data to the originator. The configuration and operation of systems of any organizational complexity becomes possible with arbitrary territorial and/or content-related bundling of the production operation by referencing these settings during instantiation of workflow processes and processing of these instances and using the technological processes described below.

A system configured with this solution can combine and process operational flows at any location on the globe in a synchronized, common flow by implementing the customizing, processing and instantiation models via the Web using RMI technology and by using decoupling of program flows by lava threads while simultaneously persisting the process flow data of the workflow instances.

In a system configured according to the solution, workflows for any number of clients can be processed and handled organizationally according to the requirements of respective firm that operates the system. This is attained by using the aforedescribed logical model both in Customizing (general, client-specific settings) as well as with the client-independent settings, where steps (optionally client-specific) are referenced in the duty-list of the users, as well as during processing of the workflow instances, because the Customizing settings are referenced for assigning tasks at the required time and thereby also for transporting the processed data automatically to the actual user and finally to the corresponding computer used, so as to minimize wait times.

A system configured with this solution is arranged with respect to the flows (workflows) to be processed in functional planes:

Customizing/Modeling

Instantiation

Processing.

The aforedescribed solution allows, with a suitable data model in conjunction with the required program logic in Customizing, to set up
Customers (Clients)
Clerks (Users)
Process steps (Steps)
Process models (Workflows)
Language variants for the presentation of menus and information to users of the system.

The logic implemented on the system for assigning process steps to users during processing implies the functional roles

Administrator

Shift supervisor/production supervisor

Clerk.

In a system “customized” based on the aforedescribed solution, an unlimited number and designation of process steps (Steps) can be combined to an unlimited number of process models (Workflows), which then can be instantiated in an arbitrary number, by representing generic, instantiatable structures for clients, users, steps and processes, when the automatic processing and communication functionalities are provided in the context of processing the workflow instances, according to the requirements of use of the system for an unlimited number of customers (Clients).

The aforedescribed system is configured for representing and controlling operational flows, which occur during editing of digital design data (advertisement, architecture/planning) by combining the representation of sequential flows with arbitrary recursions with automatic processing and communication solutions, which are laid out for communicating entire file system structures with authenticated automatic storage of the communicated structure on the respective target system, without burdening the user with the typically encountered wait times.

Because the aforedescribed solution is oriented to the market of enterprises processing voluminous digital designs, the solution combines the functionalities of a workflow system with the functionalities of a data management system. This is made possible by providing not only automatic compression and communication methods for voluminous file system data structures for the processing of the workflow instances, but also functionalities for archiving the aforementioned folder structures (client-specific), while ensuring transparent referencing for additional or repeated processing and production.

The process steps and process models can be set up and processed independently for each of the configured clients. Because there is an increasing tendency in the market towards outsourcing and concentration, the system also enables association of process steps and responsibilities beyond the client structures to users and production managers in Customizing, which causes the corresponding assignments during operation. This is made possible by corresponding data models both within Customizing, but also for the instantiation process and processing of these workflow instances in conjunction with program logic when selecting order data in the order lists of the user.

In Customizing, the process model forming the basis of the aforedescribed solution enables modeling of freely definable, sequential flows, during operation while additionally enabling the execution of arbitrary recursions over the instantiated processes and their limited modification. This is attained, in particular, by providing generic data model and program structures, the definition of arbitrary steps as nodes to be tracked in the production flow, wherein the respective production server at which that step should be performed can be referenced in any way, and simultaneously by providing automatic communication logic as well as by providing generic functionality for implementing arbitrary program logics as “INBOUND”- and “OUTBOUND”-methods under the auspices of the user of the system.

Unlike conventional workflow systems, a process model arranges the processes as process nodes (Steps), where the design data can be edited or represented, and transitions, where the referenced directory structures are transferred, and “INBOUND”-or “OUTBOUND”-methods for allowing technical modifications or communications of the design data.

At each of the process steps established in Customizing, both an “inbound”-method, which during operation is automatically executed before this step is reached within the instantiated processes, and an “outbound”-method, which is also executed automatically after exiting/completion confirmation of the step.

These methods are provided by the system with instance-related parameters and can be implemented as lava process or PERL function.

For each process step (Steps), the IP address of a production server can be set up, with the result that the editorial data are transferred to the server referenced at the next step when exiting a process step (Steps) where they are stored in the previous directory structure.

Referencing and communication of the server and work stations client computer set up in a system is performed with Java-RMI-technology. Unlike the conventional workflow systems, the disclosed solution does no longer represent the connections of nodes by way of logical transitions, but represents these transitions as independent, functional parts of the process, encapsulated in lava threads. With this technology, the code implemented in the thread can initially be executed as a self-contained, independent program. With this solution, the users of the system can be unburdened in the designated operational environment from the generally long wait times for opening and storing the voluminous data on shared file systems. By persisting the results of the program logic executed in the thread implemented with the solution, any errors that may occur in the thread can be sent back to the last user, so as to ensure consistency of the process and also to efficiently respond to errors.

With this technical solution, the users remain entirely unaffected by the potentially necessary, large expenditure of time necessary to transport voluminous data from one server to another remote server. The actual transport of the data is again performed by using Java-RMI. With this functionality and by using suitable compression methods, the complete file system structures, as they are set up by the editorial systems, can be transferred in their retained structure to a remote server in a minimum amount of time and without downtime of the system user(s).

With the threat construct, time-consuming communication between the users working on a matter can be decoupled, and errors and results of the communication can be represented in the database. The process logic of the aforedescribed system also transfers this file system structure to the client workstation, also via a RMI communication, so that the DTP application can access the data from the local file system, thus significantly shortening access times. A similar communication logic is applied in the reverse direction, when a process step is completed. The client computers of the users/clerks also communicate with their respective production server via RMI and the server address set up for that step, by executing automatic methods for the compression of the data at the source workstation, and decompression and storage in the required file system structure of the target computer. Consequently, the data to be processed are always provided to the users on the local hard drive for processing. All required communication is transparent to the user.

With these technologies in conjunction with the applied data model, the aforementioned Customizing, as well as the aforementioned process logic, the described solution makes it possible to organize and automate organizations/production flows at distributed sites, with simultaneous automatic communication of the data to be processed without wait times for the users of the system.

All settings performed in Customizing are transferred (inherited) to the instantiated processes.

All Customizing data, and all process flows and status data of the processed workflows are persisted in the database.

All systems (production server, client workstations) belonging to the system communicate with a central database server.

Use of the system provides the following advantageous effects:
Replacing “Paper control” of the production process with “Information control”,
Enabling the “digital workflow” in a preferred embodiment,
The possibility to take incorporate and control “later” changes in typesetting orders,
Significant reduction of the time required for opening and securing typesetting data of or on LAN shares by employing the technologies in the data management system,
Reduction of working hours,
Reducing the throughput time of typesetting orders by the production method (later final deadlines for advertisements are possible),
The technical communication with external customers and departments of the “parent company” can be automated,
The scheduling and organizational efficiency of the entire production process is enhanced,
Using the invention provides a competitive advantage.

An exemplary embodiment of the invention will now be described in more detail with reference to the appended drawings.

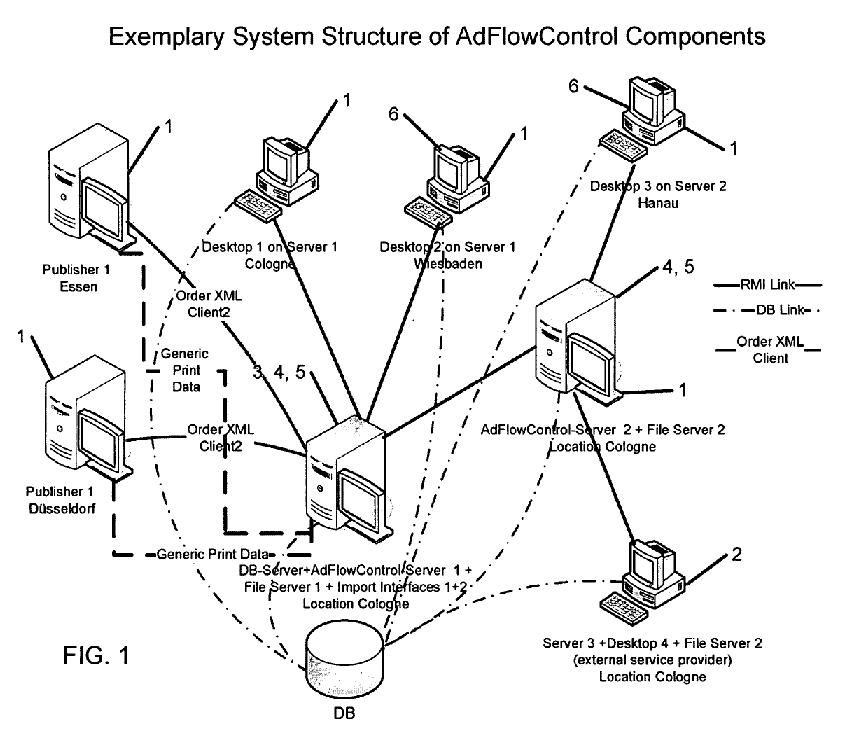

FIG. 1 shows an exemplary system structure of the components of an exemplary system for controlling the production method for advertisement designs, and

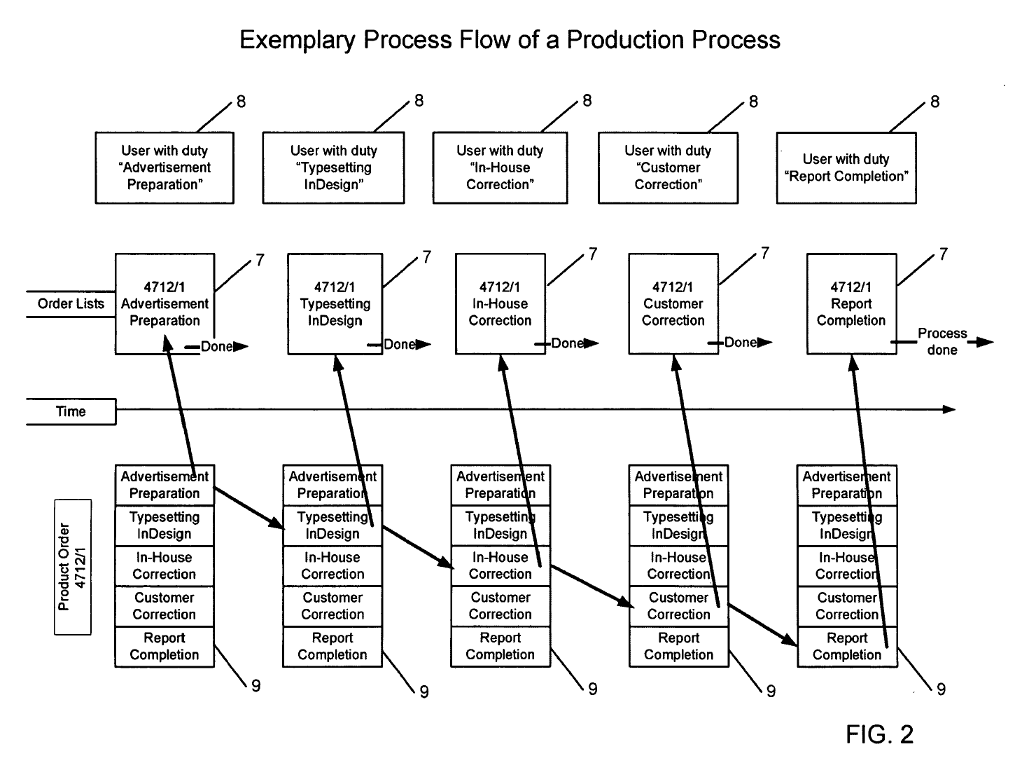

FIG. 2 shows an exemplary process flow of a production process.

The invention will be described below in detail with reference to an example for controlling a production method for advertisement designs. It should be noted, however, that the invention is not limited to the described exemplary embodiment, but can also use for controlling similar, sequential production processes.

The exemplary system for controlling the production process for advertisement designs, in the following also referred to as “AdFlowControl”, is a workflow system which represents, controls and automates the production of digitally produced advertisement designs (motifs) from the time the commercial advertisement order is stored in the advertisement management system to the time the completed designs are transferred to the corresponding communicating downstream systems as generic print data or derivatives of print data. The controller and communication characteristic of the system can be affected and set up via Customizing according to the requirements of the customer.

The system is organized in a client-server architecture. It manages the entire production flow between the commercial advertisement systems and the page assembly systems or the downstream systems to which generic print data are supplied, preferably in the pre-press regime.

Downstream systems are, in the present context, referred to as those systems and/or processes to which the design data completed with the production process are to be transmitted in a generic print format or in another format.

This can be, for example, page assembly processes, RIP systems (RIP=Raster Image Processor), OPI systems (OPI=Open Prepress Interface) or the file systems of the clients on a remote server. The exemplary workflow system “AdFlowControl” ensures that the corresponding data are automatically communicated to the corresponding system immediately after the production process is confirmed as complete.

The system is to be supplied from the advertisement management system(s) via technical interfaces with the required order data which are required—in addition to the flows to be modeled in the system—for visualizing the production processes.

“AdFlowControl” can in principle be coupled with any a number and type of advertisement management systems and can also in principle automatically supply any downstream system with generic print data and integrate any number of remote production sites 1 in the production method. (see FIG. 1).

At each site where parts of the production tasks are performed (for example with distributed production or external service providers 2), a server (UNIX/LINUX) is operating in the aforedescribed exemplary embodiment as a file server 4, on which an “AdFlowControl” production server 5 is running. A production server 5 is hereby referred to as a server machine operating under UNIX/LINUX on which an “AdFlowControl” process is running.

These server processes process the majority of all information to be processed in a production environment organized with “AdFlowControl” and provide the required processing and communication functionalities necessary in this context.

Except for the case where all servers are located in a single LAN/WAN or are connected via point-to-point connections, the servers must be identified in the exemplary embodiment with a fixed TCP/IP Internet address so as to be able to take advantage of the technical features of “AdFlowControl” (distributed production with a data management system).

In the exemplary embodiment, the minimum production infrastructure organized with “AdFlowControl” includes the following basic elements:
A database server 3,
A file server 4 (optionally the same machine as the database server 3); preferred are UNIX/LINUX machines,
An “AdFlowControl” production server 5 installed on the machine of the file server 4, and
A desktop computer 6 with the “AdFlowControl-ClientApplication”.

In a preferred embodiment, a file server 4+“AdFlowControl”-Server 5 are located according to the remote location of the production sites, at different geographic sites (see FIG. 1).

The exemplary system administers all Customizing and process information, and a part of the data of the commercial orders which are persistent in a relational database structure (preferably Oracle or MySQL).

The data required in conjunction with the technical production and generated during this production are stored in file systems (order folder).

“AdFlowControl” automatically handles the data which are generated and managed in the digital typesetting production, independent of the number and location of the participating servers.

Advantageously, at least a portion of the components of the system—preferably all relevant components—are implemented under “Java”. These components can then run on all common system platforms when using a virtual lava machine (VM).

The system described in this exemplary embodiment has the following logical/structural characteristic:
The global structure of the system is structured into the areas “Customizing” and “Production”.

a) Customizing
Clients: first, the clients whose production is to be visualized in the system need to be set up.
Users: users can be typified in the system as “administrators”, “production supervisors”, “team leaders” or “users”. With this designation, the system of the invention controls general user access to the system and the data processed in this system.
All other Customizing settings which directly or indirectly affect the production processes, must be set client-specific.
Steps 7: for each of the clients, the following processing steps/stations are to be set up on the first modeling plane.
At each step 7, an “inbound” function can be set up which is triggered, in parameter form, in the production process when the particular step 7 requiring actual processing in the process is “reached”.
At each step 7, an “outbound” function can be set up which is triggered, in parameter form, in the production process when the particular processing step/step 7 is “reported completed”, i.e., its processing is complete.
In principle, the user of the system can freely determine and define the functions of the inbound and outboard functions of steps 7.
The “inbound” and “outbound” functions in the exemplary embodiment are implemented in the program by a PERL framework, which can be used to implement almost any parameterized function and program.
Moreover, information about the particular server (file server 4 at site 1 of a decentralized production) are to be saved at each step 7 at which the process is to be performed.
For example, assuming that an external service provider 2 is to be engaged for the exemplary “Design with InDesign”, then a step 7 configured as “In-house design with InDesign” and as “Design with InDesign at the service provider” needs to be set up and saved at the corresponding employed server.
Flows: flows map typified processing flows in the form of a model.
The typified sequences of processing steps (Flow Steps) are connected/modeled as flows.
These Flows (e.g., Flows with the names: “Quark typesetting with auto correction”, comprising steps 7 “Commercial order recording”, “Advertisement preparation”, “Quark typesetting”, “In-house correction”, Production process reported Complete”) are referenced during instantiation of the production process at the import interface of the advertisement management system(s).
The production processes instantiated under the identified reference at a respective flow, in conjunction with the sequences of steps 7/processing steps referenced from these flows, enable the logical organization and on-time control of the entire production.
User-duty-lists: the steps 7 to be referenced (separated by clients) are assigned to the users in the user master data. With this assignment, the system of the invention ensures the assignment of the task to be performed to the users of the system within the production process.
In these duty lists, individual steps 7, several steps 7, or steps 7 with the same functionality can be referenced from the Customizing of different clients. As a result, lists of production orders 9 are supplied 8 to the users only, if the current (active) step 7 is included in the duty list of the involved user (see FIG. 2).

Publication structure:
In Customizing, all categories for technical output and advertisements to be produced by the corresponding publishing house (client) need to be initially set up.

Deadlines:
For issues: for each technical issue, the print date as well as a deadline-offset needs to be set up for each publishing date during a week. This deadline-offset visualizes the time that is required, after a typesetting order 9 (production order) has been completed, to generate the EPS of the entire page, ripping the page and optionally transmitting data of the entire page as well as printing plate exposure.
For categories: for each advertisement category, the print date and the deadline-offset for the corresponding publishing date of the week can be set up, if this category is periodically produced in advance (e.g., in a publishing house, the real estate ads for the Friday edition could already be pre-produced on each Wednesday).

These deadlines, which are specific for each issue and category, are used by the interface programs for determining the print, deadline and finalization dates for the respective production order 9.

The print and deadline dates remain unchanged during the “lifecycle” of the production processes, unless a short-term decision is made to pre-produce, for example, a category and this is displayed in “AdFlowControl” (this system allows changes in the running production deadlines even if the deadlines are set).

The finalization dates can be intentionally “advanced” (moved ahead of the deadline date) for individual production processes or for groups of production processes by the system functions.

The basis for controlling deadlines of the production processes in the production environment is the “finalization date” of each individual production order 9.

The order lists are always sorted based on these values, which are repeatedly selected by the users of the system via the GUI.

The content of the ordered list selected by a user depends on the duty list of the user making the selection, in addition to the processing status of all the production orders 9 to be processed.

Each order list is sorted according to the finalization dates of the production processes selected in this list. The first line in each selected order list is always the particular production order 9 (within the respective selected list) with the earliest finalization date.

“Ad FlowControl” processes these instantiated production processes with precise deadline control and a high degree of automation of the required functionalities.

“AdFlowControl” control these processes during the entire “life” of each production order 9 and therefore also permits possible repeats of sequences of process segments (for example, cross-reference from “In-house correction” to “Design typesetting with InDesign”) with continuous visualization, control and retracing of all required process steps 7. Only a single process step 7 is “active”, i.e., to be processed, in each production process. Processing each production process is visualized via the status “active”. This status “migrates” from the first process step 7 to the last process step, which indicates that the entire production process is concluded and completed. “AdFlowControl” uses its internal transport layer during “execution” of the production process to ensure that the order folder of the respective production order 9 is always on the referenced server at the time a process step 7 is processed.

The digital control principle of the system will now be described in more detail:

The production processes to be represented in “AdFlowControl” for each advertisement order (each of its motifs) are based on digital data which are transferred from the advertisement management system(s) and are supplemented during the transmission by “AdFlowControl” with data from Customizing. The processing of these production processes and the resulting control functionality of the system is based on these combined data and a corresponding program logic. “AdFlowControl” enables the transition from the conventional production control using paper manuscripts to the information control of the production.

“AdFlowControl” controls the “execution” of the respective production process with the sequential process steps 7 available at the time when a process step is reported as having been completed (see: possible changes of production processes).

The term “completed” is used in the present context synonymously for the user action performed by a logged-in user, for example, by clicking on the menu entry “Done” in the menu “General” in a detail window of the GUI (graphic user interface) of a processing step.

The user, for example an “InDesign” typesetter, views his job as repeatedly performing actual typesetting orders 9. The actual task, a defined production order 9 design, is transmitted to the hypothetical typesetter by the system based on the duty-list and the process status of the production processes.

When invoking a process step 7, the system provides all information required for executing the task on the GUI.

The hypothetical user can invoke the typesetting tool via the GUI, wherein required information with respect to the design to be implemented are transmitted by the system to the typesetting tool via an interface.

The generated event date is received back in the system (order folder). After concluding the design process of the particular order 9, the typesetter to send reports the respective process step 7 as complete. With the aforedescribed action, namely clicking on the menu entry “Completed”, the transition functions, i.e., such (parameterized) functions, which are to be triggered during transition from a n^{th} process step 7 to a m^{th} process step 7 and also for the optionally required transport of the order folder and for changing the status “active” at the processing steps 7 subsequent in the production process, are triggered depending on the results of the transition functions.

With the message Completed, triggered at the last processing step of a production process, the entire production process is reported as completed and the set-up communication functions for supplying the downstream systems are triggered, and the production process is logically terminated.

First, the production processes are instantiated upon receipt of the Flow, on which the particular production process is to be based, and which is set up in Customizing by the advertisement management system(s).

However, such production process can deviate from the initially instantiated status due to user intervention during the “lifetime” of the production process.

Such later changes can occur due to cross-references (e.g., from a process step 7 “In-house correction” to the already executed process step 7 “Typesetting design with InDesign” for the purpose of an error correction in the design), or by adding additional process steps 7 in the production process or by deleting process steps 7 from the production process, for the purpose of adapting the production process to the specific requirements.

The system will implement such changes by ensuring that all process steps 7 all implemented (even repeatedly) in the proper sequential order, by confirming of all processing, as well as by processing all optional transition functions.

Such functions are initially system-inherent and are executed by the system without intervention, depending on the constellation of the respective production process. In addition, as already mentioned, both “inbound” and “outbound” functions can be set up at each step 7. These functions are, as already described, performed automatically by the system, if originally set up, during the transition from an n^{th} process step 7 to an m^{th} process step 7, wherein at the n^{th} process step 7 the “outbound” function and at the m^{th} process step 7 the “inbound” function is triggered.

The production process proceeds depending on the results of these executed methods.

Only a single step 7 is logically and technically “active”, i.e. processed, in every production process.

The fundamental control criterion of the system is time or a deadline. Each instantiated production process is provided with a finalization date at the time of the instantiation, which is determined from the first technical print date of the corresponding advertisement order (motif) (see: deadline customizing).

In addition, the finalization date of each production order 9 can be moved “backward” while a production process is running, either individually (for example, through preparation of an advertisement based on a particular client request) or as a group of production orders 9 (by a production manager by setting up a product insert). This logically shifts the production order(s) 9 on the common timeline on which all produced production orders 9 are located, to a time “closer” to the realistic time.

In other words, the affected production orders 9 attain a higher deadline priority.

The system selects the production orders 9 to be processed in the order lists according to the sorted finalization date.

In other words, the production order 9 which is to be processed with the greatest urgency is always at the top of the corresponding order list.

The production is thereby controlled by taking into consideration the deadline requirements of each individual production order 9 in view of all production orders 9 to be produced.

The production manager(s) is/are therefore always able to identify and control the actual status of the production.

The position of the production orders 9 in the process and who last processed or is currently processing an actual production orders 9 is always evident.

“AdFlowControl” handles the information which has to this date been exchanged as order manuscripts in paper form, by storing the commercial order in the database structures in the advertisement management system(s) and provides them to any user of the system at any logical and physical location in the production process (see also detailed description of the order folders). This initially eliminates the requirement for printing and transmitting these paper documents, but also makes it unnecessary and pointless to control the production process with these documents. The second group of documents typically provided in paper form are manuscripts and notes with the design parameters which may be supplied by the customer or consultant. In a company that uses “AdFlowControl”, the production orders are offered by the system in sequential order arranged according to the deadlines, almost immediately after the commercial order has been entered.

Each user working with the system can work at any given time on only a single production order 9. A subsequent production order 9 (step 7) would be in all likelihood be called up for processing by a second user looking at the same duty list, while the first user still processes the process step 7 invoked by the first user.

It would be very difficult under the aforedescribed conditions to use design information (manuscripts) in paper form.

First, at least one reference referring to the production order 9 in paper form would have to be added to these paper documents, so that they could be placed in a traditional manner on shelves and could be retrieved again. Moreover, each user would have to walk for each individual production order 9 (or each process step 7 to be processed) to the shelf to retrieve and the again deposit the design manuscript, immediately after the processed process step 7 is reported done. Alternatively, blocks or deadlocks (such as those encountered in the traditional paper-controlled production method) would have to be tolerated in the entire production process. This would cause a statistically longer retention time of the production orders 9 in the production process and hence to a diminished production efficiency compared to a completely digital workflow solution.

The previous discussion stresses the usefulness of transitioning to an entirely digital workflow.

“AdFlowControl” offers the logical and technical prerequisites for a complete digital visualization of the work flow for advertisement production.

The system enables digital capture of the design manuscript(s) via a TWAIN interface and a locally connected scanner, or as a file via a file upload, with consistent naming of the scanned files or imported files, their transformation to JPEG format, as well as for automated storage and management in the order folder of the corresponding production order 9.

The digitized manuscripts can be visualized and optionally printed at each process step 7 of the respective production process and are hence available during the entire production flow without additional requirements. “AdFlowControl” therefore offers a digital workflow for the advertisement production with significantly less processing time than required with traditional production methods for depositing and multiple sorting of the manuscript documents, thus also minimizing potential human errors.

“AdFlowControl” provides efficient and reliable data management for all data required or generated in the production process. Altogether, the logical principle of order folders in conjunction with the system-inherent communication methods result in a significant savings of wasteful wait times and activities and hence a significant increase in the efficiency of the enterprise.

The data management of the exemplary system will now be described in more detail.

“AdFlowControl” efficiently and automatically manages all the data required for production. The fundamental element of the data to be managed is, in addition to the data persistently stored in the database structures, the order folder. The order folder of each production order 9 is, as described above, represented in the file system in form of an identical directory structure. This includes all external files associated with a production order 9 (result data of the typesetting tools, design manuscripts, locally associated logos, etc.). This order folder itself is separately stored in a directory structure. At the time a process step 7 is “active”, the storage location of the order folder is always on the server referenced by the respective process step 7, i.e., when “AdFlowControl” is properly customized, on the respective “Home” production server 5 (where the LAN of the desktop computer 6 of the user working on the “active” process step 7 is located).

The order folder is transported automatically by an internal transition function. In addition, “AdFlowControl” transports the order folder to the local hard drive when the detail window of an “active” process step 7 is invoked, because the corresponding feature “CATCH_DATA” is set at the process step 7 “to be controlled”, so that the corresponding functions (e.g., start of the typesetting application, capture of design manuscripts, display of manuscript data) can read from and store to the local hard drive. To keep the productive file systems as “lean” as possible, “AdFlowControl”, also includes an internal archive solution. This solution is technically based on the compression and communication method, like the one used by the transport layer, but saves the compressed order folders on a server to be set up in Client Customizing.

The production orders 9 to be archived are controlled cyclically based on the backlog of the corresponding production order 9 beyond its last publication date.

The aforedescribed functionality triggered by the feature “CATCH_DATA” checks the presence of the referenced order folder on the file server 4 referenced by the process step 7.

If a result of this check is negative, then the functionality attempts to obtain the order folder from the corresponding archive server for forwarding to the desktop computer 6. The totality of these methods satisfies the highest standard for efficiency, security and reliability for managing the data required and generated in the production process.

The system includes system-inherent methods for automating stereotypic parameterized functions, for example automatic compression, communication and decompression of the content of the order folders, and automatic communication of these data between potentially several file servers 4 as a component of the transport layer.

This allows “AdFlowControl” to control and automate distributed production at remote physical sites. It is here immaterial if a single enterprise processes different portions of the production from a single client at different sites, or if different parts of this enterprise process the production from different clients at different sites, or if in the latter constellation for example a processing step “receipt and processing of digitally supplied typesetting data” for several clients is processed at a single site, or if external service provider 2 should be included in parts of the production. The functional logic and the automated communication layer of “AdFlowControl” can always handle this feature efficiently and securely.

The required functionality for data communication is automatically triggered by the system when a production process, based on Customizing for distributed production, supplies different processing steps to decentralized sites (servers) for processing.

Certain methods implemented as “outbound” functions at the steps 7, which conclude the production processes, and based on the transport layer technique guarantee that the generic print data generated in the respective production process after completion of the production process are transferred to the server of the corresponding client. It will be understood that transfer of the generic print data to the page assembly process and to additional downstream systems in the own enterprise can also be handled by the system.

With the aforementioned “inbound” and “outbound” functions and the PERL framework, practically any functionality can be implemented and automatically executed when leaving (outbound) a step 7 (the step 7 reported as “Done”), and/or “before reaching” (inbound) the step 7 following in the production process.

In this way, and by executing the transitions as threads, almost any automation solution can be attained, which can then be triggered by the process logic always at the “location” required within an actual production process.

A preferred embodiment of the data management system represents a link between Internet-based communication and the processing logic, thereby enhancing the logical structures and features of the processes provided by “AdFlowControl”, with the possibility for handling distributed production.

To obviate the need for leasing and operating expensive point-to-point connections, which are presently required to operate connected IT systems, such as for example ERP solutions (which requires limitations due to cost/capacity of the lines), the aforedescribed data management system initially uses the Internet as communication backbone.

Connections with a high capacity (DSL) for “normal Internet users” with an internal channel separation for the upload channel (from the desktop computer 6 of the end user to the Internet) and the download channel (from a server in the Internet to the desktop computer 6 of the end user) are offered (asymmetric DSL) to satisfy the “normal” use (narrow channel for uploading, and broad channel for downloading). Because in a situation where companies wishing to use “AdFlowControl” to organize distributed production, the production server “at the center” and the server at the hypothetical external service provider, depending on the direction of the communication, are each both a transmitting system and a receiving system, the width of the upload channel of the employed DSL links limits the capacity. The performance of the communication is therefore relatively low as measured by the total throughput of the DSL link. However, the relatively low price of a DSL connection is advantageous.

Such connection is then similar to a Share connection in a LAN. During interactive reading and writing from the source, the user of the reading and writing application would under normal conditions and the receiving process would when using “AdFlowControl” have to tolerate downtimes for the duration of the actual communication. The situation becomes more complicated during transfer of the entire order folders by “AdFlowControl”, which would be absolutely essential due to the organization and execution of the production. Under these conditions, a directory structure varying in its structure and content volume needs to be transferred.

If this were attempted under conventional conditions, then the files would have to be archived and compressed by an archiving program (e.g., WinZip), the result would have to be transferred to a LAN Share, an e-mail or an FTP transport on another logical system, where it would be decompressed and depacketized, and finally inserted into the final directory structure in the target directory system. Under conventional conditions, this would require manual intervention which is unacceptable. Transmission of the compressed data would essentially be subject to the aforementioned limitations and consequences. For this reason the data management system implements several different solutions and technologies.
It is transparent for the end user when data are to be transferred. The required actions are triggered by the process logic based on the settings and states of the actual production processes (their process steps 7).
The system automatically determines the data to be transferred by referencing the production order 9 and its order folder which forms the basis for the actual production process.
The source production server automatically generates and compresses the archive file.
The source production server automatically “calls” the target production server receiving the compressed file based on the server addresses retrieved in the process steps 7 (based on RMI (remote method invocation)—technologies).
The compressed file is transferred in form of an argument of the method call on the remote system.
The argument is transmitted via a socket connection as a byte stream (uninterrupted data stream) (conventional transmission systems transmit the data in form of blocks, i.e., with more overhead and therefore slower).
The method executed by the source production server on the target production server decompresses and de-archives the received byte stream after saving it as a file, and moves the received directory structure (the order folder) to the particular position which is logically defined for the corresponding order motif (the corresponding production order 9).
As a result, the particular order folder directory is present in the directory structure of the target production server in the same “expanded” form it was in before on the source production server.
This method can in principle also be used for transferring the order folder (identified as “catch-data” at process step 7) from the referenced production server to the desktop computer 6, on which an AdFlowControl client program is running.
This method is also used for managing a typesetting data archive.

The same methods for compression and transmission as above are used.

However, the archive server to be set up at the respective client/large customer operates as target server. Moreover, the transmitted compressed files, which each include an order folder, are not de-packetized on the archive server, but are stored as in a packetized format again at a logical position in the file system corresponding to that in the production file systems. They therefore occupy only about 20% of the original volume.

The order folders to be archived are controlled by the system by referencing the last publication date of the advertisements motif represented by the respective production order 9.

However, the data remain available until the archive data are deleted (this corresponds to a requirement by the advertising business, because customers frequently desire to make reference in a new order to stored designs, for example for the last Easter, but with a different price). The functionality to be triggered with the feature “CATCH_DATA” checks the presence of an order folder (the corresponding directory structure) on the referenced production server 5. If nothing is found, then the referenced production server calls via RMI a method on the corresponding archive server, which returns the compressed date as a byte stream to the calling method, which is then forwarded to the corresponding method of the client program, where it is de-packetized and placed as if the byte stream had come from the referenced production server itself. This transfer is again entirely transparent for the end user

So as not to burden the end user with downtime under the aforedescribed conditions, (with the exception of point 10), caused by the expected, potentially significant processing times for the transfer, the aforedescribed communication method is “decoupled” in “AdFlowControl” control, at least as part of the transition functions to be performed during transition from an n^{th} to an m^{th} process step 7 (triggered by the Complete message at the n^{th} process step 7). In other words, all transition functions to be optionally performed (“outbound” function, transfer, “inbound function”) are stored in a thread. This represents a self-contained “program section” which is also independently executed by the Java-VM.

Such thread is started after the user of the n^{th} process step 7 has reported this step as “Completed” and after a system method has successfully executed the optional transfer of the order folder from the desktop computer 6 to the referenced production server. The detail window of the processed process step 7 is then closed, and the respective user can then immediately invoke the next step 7 for processing.

The thread methods are implemented such that the status features and error codes are written during the thread execution to the (n^{th}) process step 7 that is exited, and to the (m^{th}) process step 7 to be activated, in such a way that the n^{th} step 7 is provided with a status “PO” (pending outbound method execution) for the duration of the execution of the “outbound” function, the m^{th} step 7 is provided with a status “PT” (pending transfer) for the duration of the execution of the transfer, and finally the step 7 is provided with a status “PI” (pending inbound method execution) for the duration of the execution of the “inbound” function. Any errors are written to the n^{th} or the m^{th} step 7. Depending on the results after execution of these methods, the process “moves on”. In other words, the m^{th} process step 7 is activated (i.e., displayed to a corresponding responsible user and made invokeable for processing) only after (in the background) the required processing was successfully completed.

The end user is therefore not burdened during the entire transition, and the production managers (they receive production orders/process steps 7 that are also listed with the aforementioned transition status features) can always see what happens.

In addition to the aforedescribed advantages, the solution offers another principal automation option. By using the aforedescribed PERL framework, but also by using JAVA methods, thread decoupling allows almost any number of technical processing (especially asynchronous processing or processing with a longer processing time, or polling processes with suitable automated processing) to be logically and technically inserted into workflow processes which are enabled by the process model “AdFlowControl”.

In a preferred embodiment for implementing “outbound” and “inbound” functions, “AdFlowControl” provides a PERL framework which realizes access to PERL installed on the production server 5 via a defined PERL framework program, by providing a large parameter file. By access to the PERL language and the provided parameters, customers can become responsible for implementing program functionalities commensurate with the requirements of the respective customer. These functionalities require that a return code which is characteristic of the program implementation is returned to the aforementioned PERL framework program. “AdFlowControl” can therefore be used as a basis for implementing essentially any functionality capable of aiding the automation of process flows in the context of the workflows to be implemented.

In conjunction with the functionalities of distributed production described elsewhere, the automated communication of the order folders as well as the data management, almost any configuration of distributed production with simultaneous concentration of certain tasks and reliable control can be implemented with “AdFlowControl”.

The system is capable to integrate in Customizing any language used in the program interface. The desired language (if implemented) can be defined for each user of the system in the user directory. The system is therefore in principle capable of allowing each user of the system to select and use his/her preferred interface language. This functionality, in conjunction with the possibilities of distributed production and automated data management, allows organization and control of the production in a multilingual environment at essentially any decentralized production site.

Implementation of the invention is not limited to the preferred exemplary embodiment described above. Instead, a number of modifications can be envisioned which make use of the system and method of the invention even in fundamentally different embodiments.

### List of Reference Symbols

1 remote production site
2 external service provider
3 database server
4 file server
5 (“AdFlowControl”) production server
6 desktop computer
7 step
8 assignment of the activity to be performed, listings of a production process
9 production order, typesetting order

1.-27. (canceled)

28. A method for processing typesetting orders for advertisements in print or online media, comprising the steps of:
providing program modules on at least one data processing system, which enable modeling of predefinable processing steps in processing of typesetting orders,
associating a production process with a typesetting order, wherein the associated production process is configured from program modules and assembled as a sequence of the program modules,
during a new installation and change of a production process, automatically determining a finalization date at least for a portion of the production process and associating the determined finalization date with the production process,
matching different production processes to one another such that finalization dates of the different production processes satisfy predeterminable criteria, and prioritizing the production processes depending on their finalization dates,
releasing during processing of a typesetting order exactly one program module of the production process associated with this typesetting order for processing, and
transferring the released production process from one program module to an immediately following program module under control of a parameterizable transition function.

29. The method according to claim 28, further comprising the steps of: combining program modules and modeling typified workflows in a production process with the combined program modules as flows.

30. The method according to claim 29, further comprising the steps of:
associating a self-contained production process with each typesetting order and instantiating the production process by referencing a corresponding modeled flow, such that the production process is instantiated and processed with sequential processing steps modeled in the flow.

31. The method according to claim 30, wherein an order of the sequential processing steps is changed.

32. The method according to claim 28, wherein production processes are configured as sequential processes enabling recursion and editing.

33. The method according to claim 28, further comprising the steps of:
adding program modules to the production process or removing program modules from the production process, while the production process is performed.

34. The method according to claim 28, wherein program modules of a production process are configured to release already processed program modules of the production process for repeated processing.

35. The method according to claim 28, further comprising the steps of setting up a uniform directory structure for access by each program module, and managing at least a portion of data for a production order with the uniform directory structure.

36. The method according to claim 35, wherein the uniform directory structure enables managing of scans of design definitions.

37. The method according to claim 28, further comprising the steps of:
executing processing steps on local data processing systems located at different physical sites, where the program modules required for executing the processing steps are installed, and
transmitting the data required for executing the processing steps to the local data processing systems by way of transfer functions, or providing the data to the local data processing systems for retrieval, or both.

38. The method according to claim 35, further comprising the step of transmitting the uniform directory structure to a data processing system identified by a processed program module or providing the uniform directory structure to the local data processing system for retrieval, or both.

39. The method according to claim 37, wherein the transfer functions automatically trigger actions selected from the group consisting of PDF generation, e-mail or fax transmission, transmission of EPS data to defined addressees and setting of EPS data in a predefined visualization system.

40. The method according to claim 28, further comprising the step of providing data required for setting up a production process to at least one advertisement management system.

41. A method for data management in distributed object-oriented workflow systems using a Java RMI (Remote Method Invocation) process, comprising the steps of:
automatically starting a thread at a target data processing system to initiate transmission of data when a predetermined process step is reached,
transmitting the requested data from a source data processing system to the target data processing system in a byte stream as an argument of a method, and
saving the transmitted data on the target data processing system in a directory structure and at a storage location which correspond to a storage location and directory structure of the data on the source data processing system.

42. The method according to claim 41, wherein the data between the different data processing systems are transmitted via the Internet.

43. A system for processing of typesetting orders for advertisements in print or online media, comprising at least one data processing system with program modules which include individual predeterminable processing steps in the processing of typesetting orders, the system configured to
associate a production process with a typesetting order, wherein the associated production process is configured from program modules and assembled as a sequence of the program modules,
during a new installation and change of a production process, automatically determine a finalization date at least for a portion of the production process, and associate the determined finalization date with the production process,
match different production processes to one another such that finalization dates of the different production processes satisfy predeterminable criteria, and prioritize the production processes depending on their finalization dates,
release during processing of a typesetting order exactly one program module of the production process associated with this typesetting order for processing, and
transfer the released production process from one program module to an immediately following program module under control of a parameterizable transition function.

44. A system according to claim 43, comprising
at least one database server,
at least one file server,
at least one production server which is installed on the at least one file server, and
a plurality of desktop computers.

45. The system according to claim 44, wherein different production servers are located at different geographic locations.

46. A computer program which enables a computer, after the computer program is loaded in memory of the computer, to execute a method for processing typesetting orders for advertisements in print or online media with the steps of:
associating a production process with a typesetting order, wherein the associated production process is configured from program modules and assembled as a sequence of the program modules,
during a new installation and change of a production process, automatically determining a finalization date at least for a portion of the production process and associating the determined finalization date with the production process,
matching different production processes to one another such that finalization dates of the different production processes satisfy predeterminable criteria, and prioritizing the production processes depending on their finalization dates,
releasing during processing of a typesetting order exactly one program module of the production process associated with this typesetting order for processing, and
transferring the released production process from one program module to an immediately following program module under control of a parameterizable transition function.

47. A computer-readable storage medium, on which at least one computer program is stored, which enables a computer, after the computer program is loaded in memory of the computer, to execute a method for processing typesetting orders for advertisements in print or online media with the following process steps:
associating a production process with a typesetting order, wherein the associated production process is configured from program modules and assembled as a sequence of the program modules,
during a new installation and change of a production process, automatically determining a finalization date at least for a portion of the production process and associating the determined finalization date with the production process,
matching different production processes to one another such that finalization dates of the different production processes satisfy predeterminable criteria, and prioritizing the production processes depending on their finalization dates,
releasing during processing of a typesetting order exactly one program module of the production process associated with this typesetting order for processing, and
transferring the released production process from one program module to an immediately following program module under control of a parameterizable transition function.
